(19) United States
(12) Patent Application Publication
(10) Pub. No.: US 2007/0105592 A1
(43) Pub. Date: May 10, 2007

(54) Apparatus and method for providing neighbor node information in cellular communication system

(75) Inventors: Hyun-Jeong Kang, Seoul (KR); Pan-Yuh Joo, Seoul (KR); Jung-Je Son, Seongnam-si (KR); Jae-Weon Cho, Suwon-si (KR); Hyoung-Kyu Lim, Seoul (KR); Yeong-Moon Son, Anyang-si (KR); Sung-Jin Lee, Seoul (KR); Mi-Hyun Lee, Seoul (KR); Song-Nam Hong, Seoul (KR); Young-Ho Kim, Suwon-si (KR)

Correspondence Address: DILWORTH & BARRESE, LLP, 333 EARLE OVINGTON BLVD., SUITE 702, UNIONDALE, NY, 11553, US

(73) Assignee: SAMSUNG ELECTRONICS CO., LTD., Suwon-si (KR)

(21) Appl. No.: 11/595,079

(22) Filed: Nov. 9, 2006

(30) Foreign Application Priority Data
Nov. 9, 2005 (KR) 10-2005-0107208

(51) Int. Cl. H04B 1/38

(52) U.S. Cl. 455/561; 455/525; 370/235

(57) ABSTRACT

An apparatus and method for providing neighbor node information in a cellular communication system. In the method, a Base Station (BS) generates and transmits a neighbor advertisement message including neighbor base station BS information and neighbor Relay Station (RS) information. A node discriminatively processes the neighbor BS information and the neighbor RS information that are included in the neighbor advertisement message received from the BS. Therefore, when the neighbor advertisement message including the neighbor BS information and the neighbor RS information is broadcast, each node can extract and process necessary neighbor node information efficiently.

### PRIORITY

This application claims priority under 35 U.S.C. §119 to an application filed in the Korean Intellectual Property Office on Nov. 9, 2005 and assigned Serial No. 2005-107208, the contents of which are incorporated herein by reference.

### BACKGROUND OF THE INVENTION

1. Field of the Invention

The present invention generally relates to a cellular communication system, and in particular, to an apparatus and method for providing neighbor node information in a cellular communication system, such as a multi-hop relay Broadband Wireless Access (BWA) system in consideration of an Institute of Electrical and Electronics Engineers (IEEE) 802.16e communication terminal.

2. Description of the Related Art

Extensive research is being conducted to provide various Quality of Service (QoS) features with a data rate of about 100 Mbps in an advanced fourth-generation (4G) communication system. 4G communication systems are evolving to provide mobility, high data rate transmission, and high QoS in a BWA system, such as a Local Area Network (LAN) system and a Metropolitan Area Network (MAN) system. Typical examples of 4G communication systems are identified in IEEE 802.16d and IEEE 802.16e system standards.

IEEE 802.16d systems and BWA systems use an Orthogonal Frequency Division Multiplexing (OFDM)/Orthogonal Frequency Division Multiple Access (OFDMA) scheme. An IEEE 802.16d system considers only a fixed Subscriber Station (SS) and a single cell structure (i.e., the mobility of an SS is not considered). An IEEE 802.16e system considers the mobility of an SS. When the mobility of an SS is considered, the SS is referred to as a Mobile Station (MS).

FIG. 1 shows a conventional IEEE 802.16e system with a multi-cell structure. The conventional IEEE 802.16e system includes a cell 100, a cell 150, a Base Station (BS) 110 managing the cell 100, a BS 140 managing the cell 150, and a plurality of MSs 111, 113, 130, 151 and 153. The signal exchange between the BSs 110 and 140 and the MSs 111, 113, 130, 151 and 153 is performed using an OFDM/OFDMA scheme. The MS 130 is located in a boundary region (i.e., a handover region) between the cells 100 and 150. When the MS 130 moves from the cell 100 of the BS 110 into the cell 150 of the BS 140 while communicating with the BS 110, the serving BS of the MS 130 is changed from the BS 110 to the BS 140.

The MS may receive information about neighbor BSs from its own serving BS and acquire, from the received neighbor BS information, information about a neighbor BS suitable to perform a handover. Alternatively, the MS may perform a handover to one of the neighbor BSs and then acquire information for network re-entry.

FIG. 2 shows a procedure for exchanging the information about neighbor BSs between an MS and a serving BS in a conventional IEEE 802.16e system. A serving BS 210 and an 802.16e mode MS 240 communicate with each other in step 211. In step 213, the serving BS 210 checks the transmit (TX) period of a mobile neighbor advertisement (MOB_NBR-ADV) message including neighbor BS information during the communication.

Table 1 below shows a format of an MOB_NBR-ADV message according to the prior art.

TABLE 1

| | | Size | |
|---|---|---|---|
| Syntax | | (bits) | Notes |
| MOB_NBR- | | | |
| ADV_Message_format( ) { | | | |
| | Management Message Type | 8 | |
| = 53 | | | |
| | Skip-optional-fields bitmap | 8 | Bit[0]: if set to 1, omit Operator |

Identification (ID) field
Bit[1]: if set to 1, omit NBR BS
ID field
Bit[2]: if set to 1, omit Handover
(HO) process optimization field
Bit[3]: if set to 1, omit Quality
of Service (QoS) related fields
Bit[4]-[7]: reserved

| | |
|---|---|
| If | (Skip-optional-fields- |

| [0]=0) { | | | |
|---|---|---|---|
| | Operator ID | 24 | Unique ID assigned to the operator |

| } | | |
|---|---|---|
| Configuration Change Count | 8 | Incremented each time the |
| | | information for the associated |
| | | neighbor BS has changed. |
| Fragmentation Index | 4 | Indicates the current fragmentation |
| | | index. |
| Total Fragmentation | 4 | Indicates the total number of |
| | | fragmentations. |
| N_NEIGHBORS | 8 | |

| | |
|---|---|
| For | (j=0; |

| j<N_NEIGHBORS; j++) { | | | |
|---|---|---|---|
| | Length | 8 | Length of message information |
| | | | within the iteration of |
| | | | N_NEIGHBOR in bytes. |
| | PHY Profile ID | 8 | Aggregated IDs of Co-located |
| | | | Frequency Assignment (FA) |
| | | | indicator, FA Configuration |
| | | | Indicator, Fast Fourier Transform |
| | | | (FFT) size, Bandwidth, Operation |
| | | | Mode of the starting sub- |
| | | | channelization of a frame, and |
| | | | Channel Number |
| | if (FA Index Indicator == | | |
| 1) { | | | |
| | FA Index | 8 | This field, FA Index, is present |

only if the FA Index Indicator
in Physical (PHY) Profile ID
is set. Otherwise, the neighbor
BS has the same FA Index or the
center frequency is indicated
using the Type/Length/Value
(TLV) encoded information.

}
if (BS Effective Isotropic

| Radiated Power (EIRP) | | | |
|---|---|---|---|
| Indicator == 1) { | | | |
| | BS EIRP | 8 | Signed Integer from −128 to 127 |

in unit of dBm. This field is
present only if the BS EIRP
indicator is set in PHY Profile
ID. Otherwise, the BS has the
same EIRP as the serving BS.

| } | |
|---|---|
| If | (Skip-optional- |

| fields[1]=0) { | | | |
|---|---|---|---|
| | Neighbor BSID | 24 | This is an optional field for |

| | | OFDMA PHY and it is omitted |
|---|---|---|
| | | or skipped if Skip optional |
| | | fields Flag = 1 |
| } | | |
| Preamble Index/Subchannel | 8 | For the Sub-Channel (Sca) and |

| Index | OFDMA PHY this parameter |
|---|---|
| | defines the PHY specific |
| | preamble. For the OFDM PHY |
| | the 5 Least Significant Bit |
| | (LSB) contain the active DL |
| | subchannel index. The 3 Most |
| | Significant Bit (MSB) shall be |
| | Reserved and set to ‘0b00’. |

| | |
|---|---|
| if | (Skip-optional- |

| fields[2]=0) { | | | |
|---|---|---|---|
| | HO Process Optimization | 8 | HO process Optimization is provided |

as part of this message is
indicative only. HO process
requirements may change at time of
actual HO. For each Bit location,
a value of 0 indicates the
associated reentry management
messages shall be required, a value
of 1 indicates the reentry
management messages may be omitted.
Regardless of the HO Process
Optimization TLV settings, the
target BS may send unsolicited
Subscriber station's Basic
Capability SBC-RSP and/or
REQ-RSP management messages
Bit#0: Omit SBC-REQ/RSP
management messages during re-entry
processing
Bit#1: Omit Privacy Key Management
(PKM) Authentication phase
except Traffic Encryption Key
(TEK) phase during current
re-entry processing
Bit#2: Omit PKM TEK creation
phase during re-entry processing
Bit#3: Omit REG-REQ/RSP
management messages during current
re-entry processing
Bit#4: Omit Network Address
Acquisition management messages
during current reentry processing
Bit#5: Omit Time of Day
Acquisition management during
current reentry processing
Bit#6: Omit Trivial File Transfer
Protocol (TFTP) management
messages during current re-entry
processing
Bit#7: Full service and
operational state transfer or
sharing between serving BS and
target BS (Automatic Repeat
reQuest (ARQ), timers, counters,
Medium Access Control (MAC) state
machines, etc)

| } | |
|---|---|
| if | (Skip-optional-fields- |

| [3]=0) { | | | | |
|---|---|---|---|---|
| | Scheduling | Service | 8 | Bitmap to indicate if BS supports |

| Supported | | | a particular scheduling service. 1 |
|---|---|---|---|
| | | | indicates support, 0 indicates no |
| | | | support: |
| | | | bit 0: Unsolicited Grant Service |
| | | | (USG) |
| | | | bit 1: Real-time Polling service |
| | | | (rtPS) |
| | | | bit 2: Non-real-time Polling |
| | | | service (nrtPS) |
| | | | bit 3: Best Effort |
| | | | bit 4: Extended real-time Polling |
| | | | Service (ertPS) |
| | | | If the value of bit 0 through bit |
| | | | 4 is 0b00000, it indicates no |
| | | | information on service available. |
| | | | bits 5-7: reserved; shall be set |
| | | | to zero |
| | Reserved | 4 | Shall be set to zero |

| | } | | | | |
|---|---|---|---|---|---|
| | DCD Configuration Change | | | 4 | This represents the 4 Least |
| | | | | | Significant |
| Count | | | | | Bits (LSBs) of the Neighbor BS |
| | | | | | current Downlink Channel |
| | | | | | Description (DCD) configuration |
| | | | | | change count |
| | UCD Configuration Change | | | 4 | This represents the 4 LSBs of the |
| Count | | | | | Neighbor BS current Uplink Channel |
| | | | | | Description (UCD) configuration |
| | | | | | change count |
| | TLV | Encoded | Neighbor | vari- | TLV specific |

| | |
|---|---|
| Information | able |

}

}

As shown in Table 1, the MOB_NBR-ADV message includes the type of a TX message (Management Message Type), the number of neighbor BSs (N_NEIGHBORS), IDs of the neighbor BSs, the preamble indexes of the neighbor BSs (Preamble Index), the information about physical channel profile (e.g., physical channel frequency) for the neighbor BSs (PHY Profile ID), handover process optimization information for the neighbor BSs (HO Process Optimization), and other neighbor BS information (TLV Encoded Neighbor Information).

As a result of the check operation in step 213, when the TX period of the MOB_NBR-ADV message begins, the serving BS 210 broadcasts the MOB_NBR-ADV message to 802.16e mode MSs in its cell area, in step 215. Upon receipt of the MOB_NBR-ADV message, the MS 240 acquires the neighbor BS information from the received MOB_NBR-ADV message.

Because a signaling communication between a stationary BS and an MS is performed through a direct link, as shown in FIG. 1, a conventional IEEE 802.16e system can easily establish a highly reliable wireless link between the BS and the MS. However, because the BS is stationary, a conventional IEEE 802.16e system has a low flexibility in constructing a wireless network. Accordingly, the use of a conventional IEEE 802.16e system makes it difficult to provide an efficient communication service in a radio environment where traffic distribution or call parameters change frequently.

In order to overcome this problem, a stationary relay station (RS), a mobile RS or general MSs can be used to apply a multi-hop relay data transmission scheme to a general cellular communication system, such as an IEEE 802.16e system. The use of a multi-hop relay wireless communication system makes it possible to reconfigure a network in rapid response to a change in the communication environment, and to operate the entire wireless network more efficiently. For example, a multi-hop relay wireless communication system can expand a cell coverage area and increase a system capacity. When channel conditions between a BS and an MS are poor, an RS is installed between the BS and the MS to establish a multi-hop relay link therebetween, thereby making it possible to provide the MS with a radio channel having better channel conditions. In addition, a multi-hop relay scheme is used in a cell boundary region with poor channel conditions, thereby making it possible to provide a high-rate data channel and to expand the cell coverage area.

FIG. 3 shows a BWA system that uses a multi-hop relay scheme to expand a BS coverage area according to the prior art. The multi-hop relay BWA system has a multi-cell structure, and includes a cell 300, a cell 340, a BS 310 managing the cell 300, a BS 350 managing the cell 340, a plurality of MSs 311 and 313 located within the cell 300, a plurality of MSs 321 and 323 located in a region 330 outside the cell 300 of the BS 310 and communicating with the BS 310, an RS 320 providing a multi-hop relay path between the BS 310 and the MSs 321 and 323 located in the region 330, a plurality of MSs 351, 353 and 355 located in the cell 340, a plurality of MSs 361 and 363 located in a region 370 outside the cell 340 of the BS 350 and communicating with the BS 350, and an RS 360 providing a multi-hop relay path between the BS 350 and the MSs 361 and 363 located in the region 370. An OFDM/OFDMA scheme is used for communication among the BSs 310 and 350, the RSs 320 and 360, and the MSs 311, 313, 321,323, 351, 353, 355, 361, and 363.

The MSs 311 and 313 located in the cell 300 and the RS 320 can directly communicate with the BS 310, but the MSs 321 and 323 located in the region 330 cannot directly communicate with the BS 310. Therefore, the RS 320 covers the region 330 to relay signals between the BS 310 and the MSs 321 and 323. That is, the MSs 321 and 323 can communicate with the BS 310 through the RS 320. Likewise, the RS 360 and the MSs 351, 353, and 355 located in the cell 340 can directly communicate with the BS 350, but the MSs 361 and 363 located in the region 370 cannot directly communicate with the BS 350. Therefore, the RS 360 covers the region 370 to relay signals between the BS 350 and the MSs 361 and 363. That is, the MSs 361 and 363 can communicate with the BS 350 through the RS 360.

FIG. 4 is shows a BWA system that uses a multi-hop relay scheme to increase the system capacity according to the prior art. The multi hop relay BWA system includes a BS 410, a plurality of MSs 411, 413, 421, 423, 431, and 433, and RSs 420 and 430 providing multi-hop paths between the BS 410 and the MSs 411, 413, 421, 423, 431, and 433. The BS 410, the MSs 411, 413, 421, 423, 431, and 433, and the RSs 420 and 430 communicate with one another by an OFDM/OFDMA scheme. The BS 410 manages a cell 400. The RSs 420 and 430 and the MSs 411, 413, 421, 423, 431, and 433 that are in the cell 400 directly communicate with the BS 410.

When some MSs 421, 423, 431, and 433 are in a boundary region of the cell 400, Signal to Noise Ratios (SNRs) of direct links between the BS 410 and the MSs 421, 423, 431, and 433 can be low. In this case, the RS 420 relays unicast traffic between the BS 410 and the MSs 421 and 423. The MSs 421 and 423 make unicast communication with the BS via the RS 420. Likewise, the RS 430 relays unicast traffic between the BS 410 and the MSs 431 and 433. The MSs 431 and 433 make unicast communication with the BS via the RS 430. That is, the RSs 420 and 430 provide high-rate data paths to the MSs 421, 423, 431, and 433, thereby increasing the effective transfer rates of the MSs 421, 423, 431, and 433 and the capacity of the multi-hop relay BWA system.

In the multi-hop relay BWA systems of FIGS. 3 and 4, the RSs 320, 360, 420, and 430 may be infrastructure RSs that are installed by a service provider and managed by the BSs 310, 350, and 410 or may be client RSs that operate as SSs, MSs, or RSs according to situations. In addition, the RSs 320, 360, 420, and 430 may be stationary RSs, nomadic RSs, such as notebooks, or mobile RSs having mobility like an MS.

In such a multi-hop relay wireless communication system, a BS managing each cell must transmit to MSs of the cell not only information about neighbor BSs but also information about RSs for expanding/increasing the area/capacity of the cell. Moreover, an MS performing a conventional IEEE 802.16e communication mode and another MS performing a multi-hop relay communication mode may coexist in the cell managed by the BS.

Accordingly, a BS must transmit not only neighbor BS information but also neighbor RS information using the MOB_NBR-ADV message (defined in Table 1). What is therefore needed is a method that enables an MS performing a conventional IEEE 802.16e communication mode and an MS performing a multi-hop relay communication mode to discriminate between neighbor BS information and neighbor RS information based on an MOB_NBR-ADV message.

### SUMMARY OF THE INVENTION

An object of the present invention is to substantially solve at least the above problems and/or disadvantages and to provide at least the advantages below. Accordingly, an object of the present invention is to provide an apparatus and method for providing neighbor node information in a cellular communication system. The present invention also provides an apparatus and method for discriminatively processing neighbor BS information and neighbor RS information, which are contained in a received neighbor advertisement message, in a multi-hop relay BWA system.

Another object of the present invention is to provide an apparatus and method for providing neighbor node information in a multi-hop relay BWA system in consideration of an 802.16e mode MS.

According to one aspect of the present invention, there is provided a method for transmitting a neighbor advertisement message in a cellular communication system using a multi-hop relay scheme, the method including generating a neighbor advertisement message including neighbor BS information and neighbor RS information; and processing and broadcasting the generated neighbor advertisement message in accordance with a transport protocol.

According to another aspect of the present invention, there is provided a method for processing a neighbor advertisement message in a cellular communication system using a multi-hop relay scheme, the method including receiving a neighbor advertisement message broadcast by a BS, and discriminatively processing neighbor BS information and neighbor RS information that are included in the neighbor advertisement message.

According to a further aspect of the present invention, there is provided a BS apparatus for a cellular communication system using a multi-hop relay scheme, the BS apparatus including a message generator for generating a neighbor advertisement message including neighbor BS information and neighbor RS information, and a transmitter for processing and broadcasting the generated neighbor advertisement message in accordance with a transport protocol.

According to still another aspect of the present invention, there is provided a node apparatus for a cellular communication system using a multi-hop relay scheme, the node apparatus including a receiver for receiving a neighbor advertisement message broadcast by a BS, and a message processor for discriminatively processing neighbor BS information and neighbor RS information that are included in the received neighbor advertisement message.

According to yet another aspect of the present invention, there is provided a method for communicating a neighbor advertisement message in a cellular communication system using a multi-hop relay scheme, the method including generating and broadcasting, at a BS, a neighbor advertisement message including neighbor base station BS information and neighbor RS information, and discriminatively processing, at a node, the neighbor BS information and the neighbor RS information that are included in the neighbor advertisement message received from the BS.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of a conventional IEEE 802.16e system;

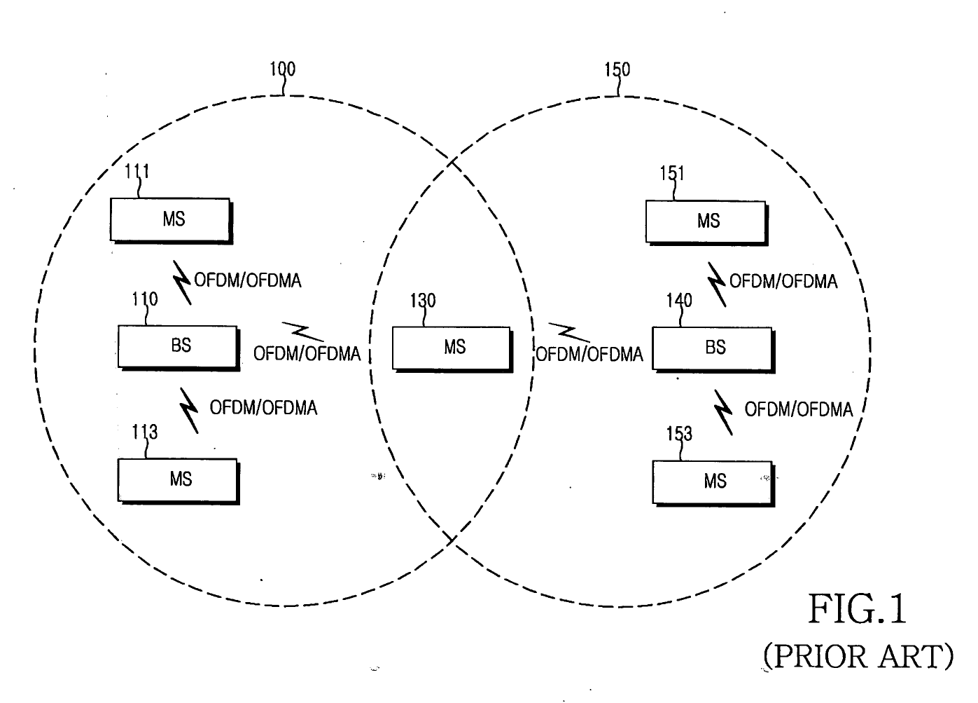

FIG. 2 is a flow diagram illustrating a procedure for exchanging the information about neighbor BSs between an MS and a serving BS in a conventional IEEE 802.16e system;

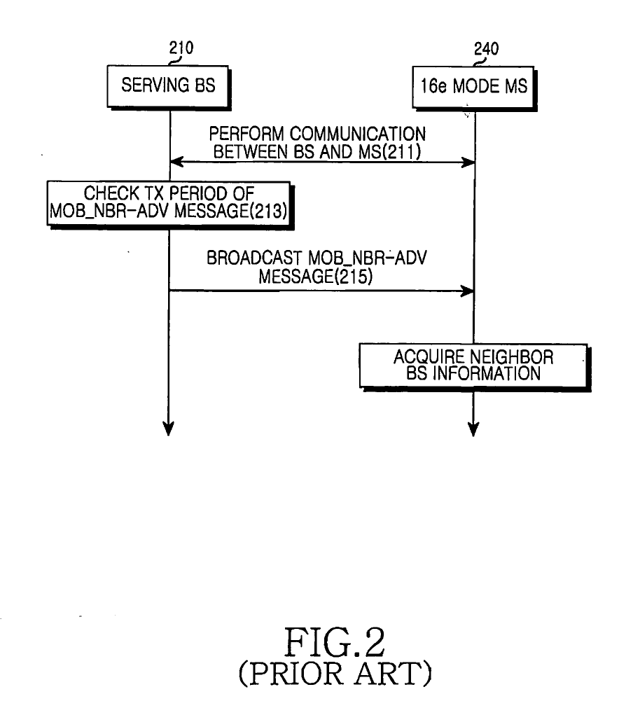

FIG. 3 is a block diagram illustrating a BWA system that uses a multi-hop relay scheme to expand a BS coverage area according to the prior art;

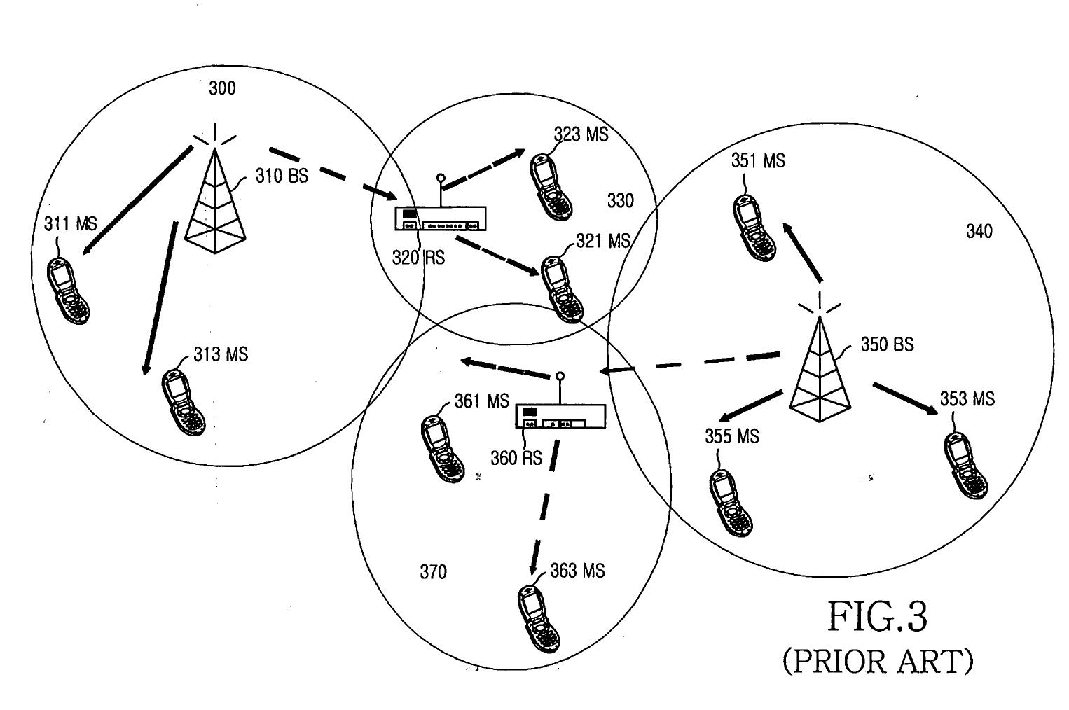

FIG. 4 is a block diagram illustrating a BWA system that uses a multi-hop relay scheme to increase the system capacity according to the prior art;

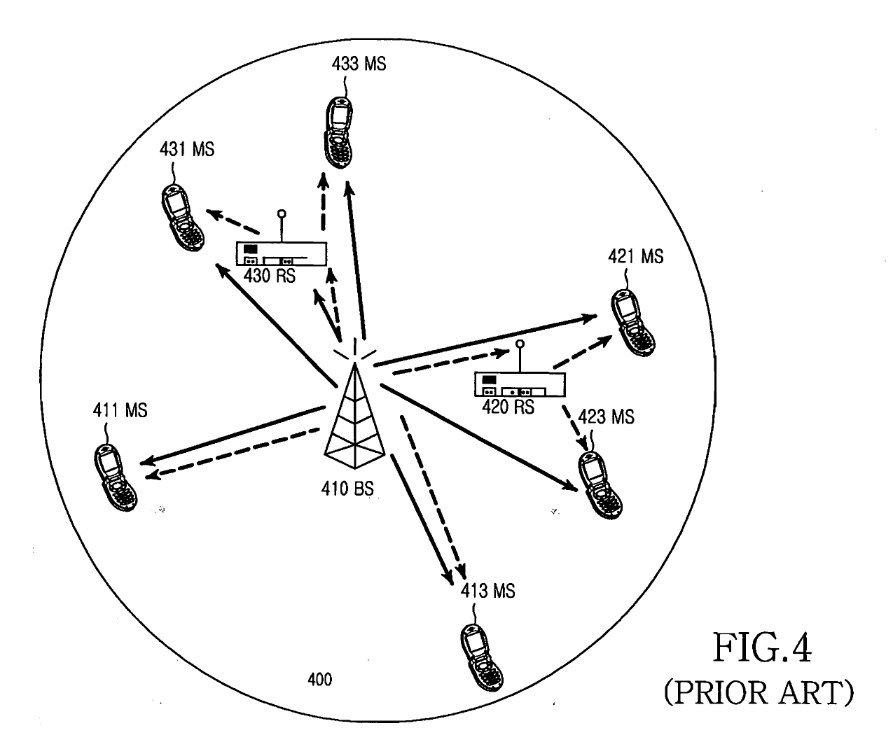

FIG. 5 is a flowchart illustrating a procedure for receiving and processing a neighbor advertisement message in a multi-hop relay BWA system according to a first embodiment of the present invention;

FIG. 6 is a flowchart illustrating a procedure for receiving and processing a neighbor advertisement message in a multi-hop relay BWA system according to a second embodiment of the present invention;

FIG. 7 is a flowchart illustrating a procedure for receiving and processing a neighbor advertisement message in a multi-hop relay BWA system according to a third embodiment of the present invention;

FIG. 8 is a flowchart illustrating a procedure for receiving and processing a neighbor advertisement message in a multi-hop relay BWA system according to a fourth embodiment of the present invention; and

FIG. 9 is a block diagram of an 802.16e mode MS (a relay mode MS, an RS, or a BS) in a multi-hop relay BWA system according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail. Also, the terms used herein are defined according to the functions of the present invention. Thus, the terms may vary depending on user's or operator's intension and usage. That is, the terms used herein must be understood based on the descriptions made herein.

The present invention provides an apparatus and method for providing neighbor node information in a cellular communication system. The present invention also provides an apparatus and method for discriminatively processing neighbor Base Station (BS) information and neighbor Relay Station (RS) information, which are contained in a received neighbor advertisement message, in a multi-hop relay Broadband Wireless Access (BWA) system.

A multi-hop relay BWA system uses an Orthogonal Frequency Division Multiplexing (OFDM) scheme or an Orthogonal Frequency Division Multiple Access (OFDMA) scheme, for example. Accordingly, a multi-hop relay BWA system can transmit physical channel signals using a plurality of subcarriers, thereby enabling high-rate data transmission. In addition, a multi-hop relay BWA system supports a multi-cell structure, thereby supporting the mobility of a mobile station (MS).

An RS for a multi-hop relay BWA system may be a stationary node, a mobile node, a specific system installed for a BS, or a general subscriber terminal. Such a node may be selected as an RS through an RS capability negotiation process in accordance with a standard for expansion of the cell coverage or capacity of a BS.

Although a multi-hop relay BWA system is taken as an example in the following description, the present invention can be applied to any cellular communication system that uses a multi-hop relay scheme.

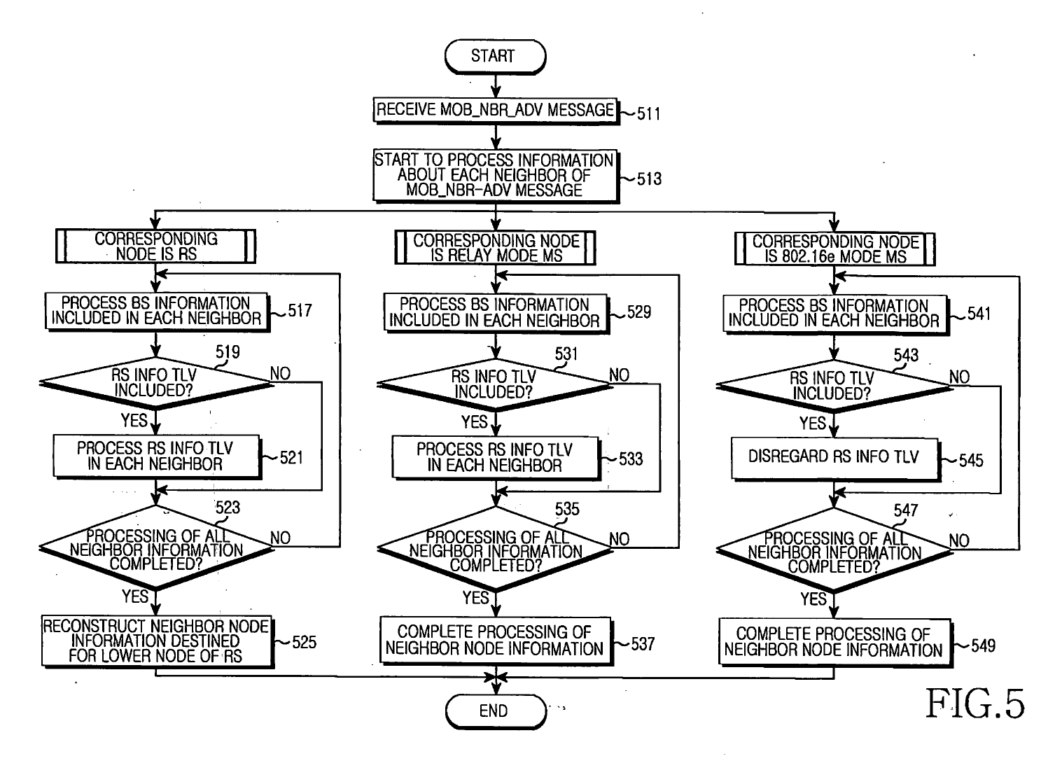

FIG. 5 shows an example of a procedure for receiving and processing a neighbor advertisement message in a multi-hop relay BWA system according to the present invention. A node receiving the neighbor advertisement message may be an RS, an MS capable of performing relay communication (hereinafter referred to as “relay mode MS”), or an MS communicating directly with a BS (hereinafter referred to as “802.16e mode MS”). The 802.16e mode MS is incapable of performing relay communication.

Referring to FIG. 5, a node receives a neighbor advertisement (MOB_NBR-ADV) message broadcast by a BS, in step 511. For example, the MOB_NBR-ADV message has the same format as that defined in Table 1, and may include not only neighbor BS information but also neighbor RS information to support a multi-hop relay communication mode according to the present invention. The neighbor RS information of the MOB_NBR-ADV message may be included in the Type/Length/Value (TLV) Encoded Neighbor information (defined in Table 1) in the TLV format so the 802.16e mode MS can acquire the neighbor BS information from the MOB_NBR-ADV message and can disregard the neighbor RS information for the multi-hop relay communication mode.

Table 2 below shows an example of RS information TLV in which the RS information is recorded according to the present invention.

TABLE 2

| | Length | |
|---|---|---|
| Type | (byte) | Value |
| Neighbor Node (NN) (RS Info) | variable | RS information |
| NN. 1 (RS identification info) | 1 | RS identification information |
| NN. 2 (PHY synchronization | 1 | PHY synchronization |
| info 1) | | information #1 |
| NN. 3 (PHY synchronization | 1 | PHY synchronization |
| info 2) | | information #2 |
| . . . | | |
| NN.xx (scheduling info) | 1 | RS scheduling information |
| . . . | | |
| NN.yy (DCD info) | 1 | RS's DCD information |
| . . . | | |

As shown in Table 2, the RS information TLV includes TLV type Neighbor Node (NN), TLV length, and a variety of RS information. The RS information may include information about RSs managed by a corresponding BS, information about the respective RS identifications (IDs). For each RS, the RS information may include RS ID information, RS PHY synchronization information (e.g., RS frequency information, and physical channel profile information), RS scheduling information supported by the RS, and information about an RS Downlink Channel Description (DCD) message or an RS Uplink Channel Description (UCD) message transmitted by the RS. Although only a portion of the RS information is shown in Table 2, the RS information may include a variety of other information like the BS information defined in Table 1.

In step 513, the node starts to process information about each NEIGHBOR of the MOB_NBR-ADV message including the RS information TLV as described above. A plurality of NEIGHBORs included in the MOB_NBR-ADV message may be sequentially processed. The subsequent process for each type of node will now be described in detail.

A case where the node receiving the MOB_NBR-ADV message is an RS supporting a multi-hop relay communication mode will be described first.

In step 517, the node (RS) processes neighbor BS information included in a corresponding NEIGHBOR.

In step 519, the node (RS) processes TLV encoding information included in the corresponding NEIGHBOR (Encoded Neighbor Information) and determines if the TLV encoding information includes RS information TLV as defined in Table 2. If so, the procedure proceeds to step 521; and if not, the procedure proceeds directly to step 523. In step 521, the node (RS) processes the RS information TLV included in the corresponding NEIGHBOR.

In step 523, the node (RS) determines if processing of information about all NEIGHBORS included in the received MOB_NBR-ADV message is completed. If so, the procedure proceeds to step 525; and if not, the procedure returns to step 517 to process information about the next NEIGHBOR. In step 525, the node (RS) reconstructs the neighbor BS/RS information in the received MOB_NBR-ADV message to generate a neighbor node information message, and transmits the generated neighbor node information message to lower nodes managed by the node (RS).

A case where the node receiving the MOB_NBR-ADV message is an MS supporting a multi-hop relay communication mode will now be described.

In step 529, the node (relay mode MS) processes neighbor BS information included in a corresponding NEIGHBOR.

In step 531, the node (relay mode MS) processes TLV encoding information included in the corresponding NEIGHBOR (Encoded Neighbor Information) and determines if the TLV encoding information includes RS information TLV as defined in Table 2. If so, the procedure proceeds to step 533; and if not, the procedure proceeds directly to step 535. In step 533, the node (relay mode MS) processes the RS information TLV included in the corresponding NEIGHBOR.

In step 535, the node (relay mode MS) determines if processing of information about all NEIGHBORS included in the MOB_NBR-ADV message is completed. If so, the procedure proceeds to step 537; and if not, the procedure returns to step 529 to process information about the next NEIGHBOR. In step 537, the node (relay mode MS) completes processing of neighbor node information.

A case where the node receiving the MOB_NBR-ADV message is an MS supporting a conventional IEEE 802.16e communication mode will now be described.

In step 541, the node (802.16e mode MS) processes neighbor BS information included in a corresponding NEIGHBOR.

In step 543, the node (802.16e mode MS) processes TLV encoding information included in the corresponding NEIGHBOR (Encoded Neighbor Information) and determines if the TLV encoding information includes RS information TLV as defined in Table 2. If so, the procedure proceeds to step 545; and if not, the procedure proceeds directly to step 547. At this point, the node (802.16e mode MS) does not know a type value NN corresponding to the RS information TLV. Therefore, the node (802.16e mode MS) cannot process the RS information TLV even when the type value NN is included in the TLV encoding information (Encoded Neighbor Information).

Accordingly, in step 545, the node (802.16e mode MS) disregards (or discards) the RS information TLV and processes only recognizable TLV encoding information.

In step 547, the node (802.16e mode MS) determines if processing of information about all NEIGHBORS included in the MOB_NBR-ADV message is completed. If so, the procedure proceeds to step 547; and if not, the procedure returns to step 541 to process information about the next NEIGHBOR. In step 547, the node (802.16e mode MS) completes processing of neighbor node information.

As described above, this example uses the format of the MOB_NBR-ADV message (defined in Table 1) as it is. That is, the 802.16e mode MS can acquire the neighbor BS information in the same manner as conventional art, without recognizing the neighbor RS information (defined in Table 2) added to a conventional MOB_NRB-ADV message (defined in Table 1).

Unlike a conventional MOB_NBR_ADV message defined in Table 1, an MOB_NBR-ADV message according to the present invention includes neighbor RS information for a multi-hop relay communication mode, as well as neighbor BS information for a conventional IEEE 802.16e communication mode. In this case, an indicator is used to indicate whether the NEIGHBOR information is RS information or BS information. This will be described below.

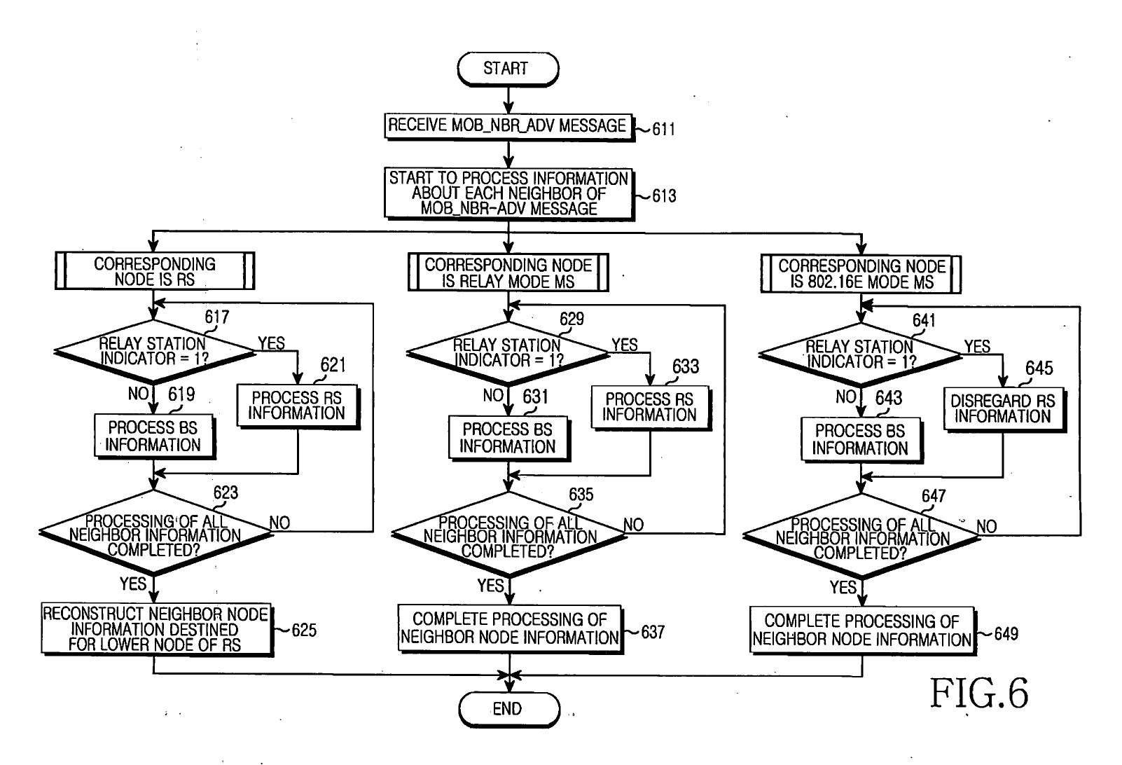

FIG. 6 shows another example of a procedure for receiving and processing a neighbor advertisement message in a multi-hop relay BWA system according to the present invention. A node receiving the neighbor advertisement message may be an RS, a relay mode MS, or an 802.16e mode MS.

Referring to FIG. 6, a node receives a neighbor advertisement (MOB_NBR-ADV) message broadcast by a BS, in step 611. The MOB_NBR-ADV message may include neighbor RS information for supporting the multi-hop relay communication mode, as well as the neighbor BS information defined in Table 1. In addition, the MOB_NBR-ADV message may further include a relay station indicator for indicating the existence of the neighbor RS information, so the RS, the 802.16e mode MS, or the relay mode MS can detect that the neighbor RS information as well as the neighbor BS information is included in the MOB_NBR-ADV message.

Table 3 below shows an example of a format of the MOB_NBR-ADV message including an RS indicator according to the present invention. An MOB_NBR-ADV message according to this example includes not only the information defined in Table 1 but also an RS indicator for indicating whether corresponding NEIGHBOR information is RS information.

TABLE 3

| ... | . . . | . . . |
|---|---|---|
| N_NEIGHBORS | 8 | Number of neighbor RSs |
| | | and BSs |

| | |
|---|---|
| For(i=0; | i<N_NEIGHBORS |

| i++) { | | | |
|---|---|---|---|
| | Relay station indicator | 1 | 0: base station |
| | | | 1: relay station |
| | Reserved | 7 | Shall be set to zero |
| | Length | 8 | Length of message |
| | | | information within the |
| | | | iteration of |
| | | | N_NEIGHBORS in bytes. |
| | PHY synchronization info | TBD | Information for physical |
| | | | synchronization |
| | Neighbor station info | TBD | Information of this |
| | | | neighbor station |
| | TLV encoded neighbor | Vari- | TLV specific |

| | |
|---|---|
| information | able |
| } | |

As shown in Table 3, the MOB_NBR-ADV message includes a relay station indicator that is added to each NEIGHBOR information in a conventional MOB_NBR-ADV message (defined in Table 1) to indicate whether the NEIGHBOR is a neighbor BS or a neighbor RS. When the RS indicator is ‘0’, it indicates that a corresponding NEIGHBOR is a neighbor BS. When the RS indicator is ‘1’, it indicates that a corresponding NEIGHBOR is a neighbor RS. If the RS indicator ‘1’ indicating a neighbor RS, a portion of the information included in a conventional MOB_NBR-ADV message (defined in Table 1) may be omitted.

In step 613, the node starts to process information about each NEIGHBOR of the MOB_NBR-ADV message including an RS indicator. A plurality of NEIGHBORs included in the MOB_NBR-ADV message may be sequentially processed. The subsequent process for each type of node will now be described in detail.

A case where the node receiving the MOB_NBR-ADV message is an RS supporting a multi-hop relay communication mode will be described first.

In step 617, the node (RS) determines if the RS indicator in the corresponding NEIGHBOR information is ‘1’. If not, the procedure proceeds to step 619; and if so, the procedure proceeds to step 621. In step 619, the node (RS) processes BS information corresponding to the NEIGHBOR information. In step 621, the node (RS) processes RS information corresponding to the NEIGHBOR information.

In step 623, the node (RS) determines if processing of information about all NEIGHBORS included in the MOB_NBR-ADV message is completed. If so, the procedure proceeds to step 625; and if not, the procedure returns to step 617 so as to process information about the next NEIGHBOR. In step 625, the node (RS) reconstructs neighbor BS/RS information included in the MOB_NBR-ADV message to generate a neighbor node information message, and transmits the generated neighbor node information message to lower nodes managed by the node (RS).

A case where the node receiving the MOB_NBR-ADV message is an MS supporting a multi-hop relay communication mode will now be described.

In step 629, the node (relay mode MS) determines if an RS indicator in the corresponding NEIGHBOR information is ‘1’. If not, the procedure proceeds to step 631; and if so, the procedure proceeds to step 633. In step 631, the node (relay mode MS) processes neighbor BS information corresponding to the NEIGHBOR information. In step 633, the node (relay mode MS) processes neighbor RS information corresponding to the NEIGHBOR information.

In step 635, the node (relay mode MS) determines if processing of information about all NEIGHBORS included in the MOB_NBR-ADV message is completed. If so, the procedure proceeds to step 637; and if not, the procedure returns to step 629 so as to process information about the next NEIGHBOR. In step 637, the node (relay mode MS) completes processing of neighbor node information.

A case where the node receiving the MOB_NBR-ADV message is an MS supporting a conventional IEEE 802.16e communication mode will now be described.

In step 641, the node (802.16e mode MS) determines if an RS indicator in the corresponding NEIGHBOR information is ‘1’. If not, the procedure proceeds to step 643; and if so, the procedure proceeds to step 645. In step 643, the node (802.16e mode MS) processes BS information corresponding to the NEIGHBOR information. In step 645, the node (802.16e mode MS) disregards RS information corresponding to the NEIGHBOR information.

In step 647, the node (802.16e mode MS) determines if processing of information about all NEIGHBORS included in the MOB_NBR-ADV message is completed. If so, the procedure proceeds to step 649; and if not, the procedure returns to step 641 so as to process information about the next NEIGHBOR. In step 649, the node (802.16e mode MS) completes processing of neighbor node information.

According to this example, using an RS indicator added to a conventional MOB_NBR-ADV message, the 802.16e mode MS can determine whether the corresponding NEIGHBOR information is the neighbor BS information or information about other nodes.

Unlike a conventional MOB_NBR_ADV message defined in Table 1, an MOB_NBR-ADV message according to the present invention includes neighbor RS information for the multi-hop relay communication mode, as well as neighbor BS information for a conventional IEEE 802.16e communication mode. In this case, an indicator is used to indicate whether the NEIGHBOR information includes neighbor RS information. This will be described below.

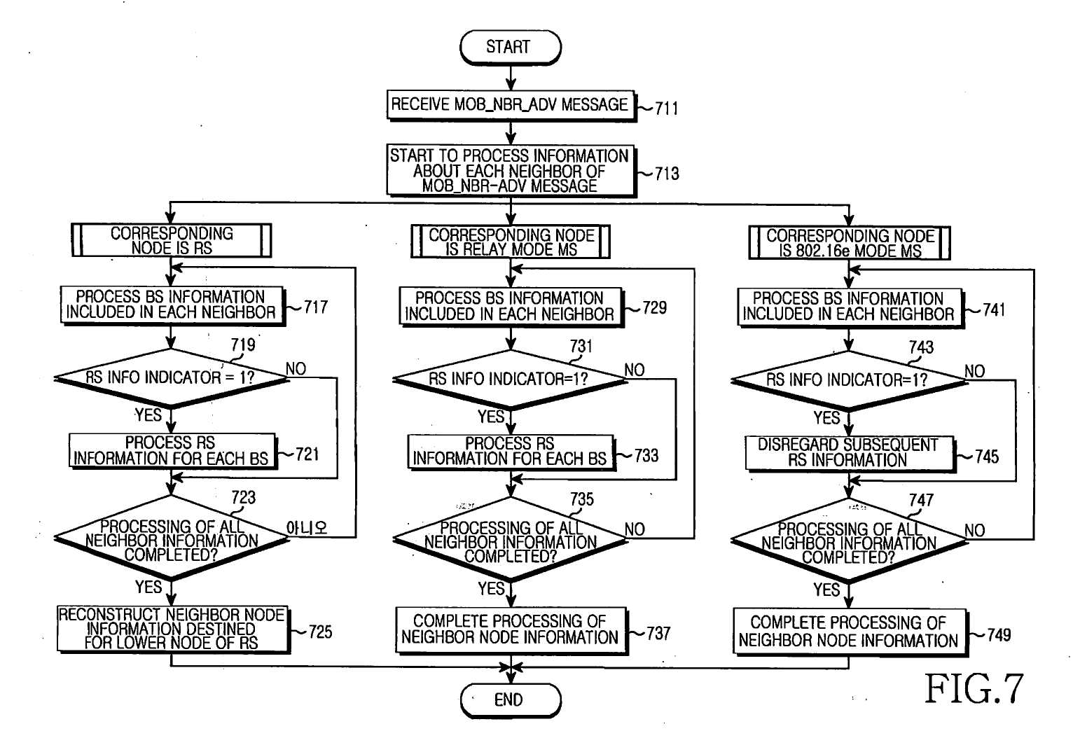

FIG. 7 shows an example of a procedure for receiving and processing a neighbor advertisement message in a multi-hop relay BWA system according to the present invention. A node receiving the neighbor advertisement message may be an RS, a relay mode MS, or an 802.16e mode MS.

Referring to FIG. 7, a node receives a neighbor advertisement (MOB_NBR-ADV) message broadcast by a BS, in step 711. The MOB_NBR-ADV message may include neighbor RS information for supporting a multi-hop relay communication mode, as well as the neighbor BS information defined in Table 1. In addition, the MOB_NBR-ADV message may further include a relay info indicator for indicating the existence of the neighbor RS information, so the RS, the 802.16e mode MS, or the relay mode MS can detect that the neighbor RS information as well as the neighbor BS information is included in the MOB_NBR-ADV message.

Table 4 below shows an example of a format of an MOB_NBR-ADV message including the relay info indicator according to the present invention. A MOB_NBR-ADV message according to this example includes not only the information defined in Table 1 but also the relay info indicator for indicating whether corresponding NEIGHBOR information includes neighbor RS information.

TABLE 4

| ... | | . . . | . . . |
|---|---|---|---|
| N_NEIGHBORS | | 8 | Number of neighbor BSs |
| For(i=0; i<N_NEIGHBORS | | | |
| i++) { | | | |
| | Length | 8 | Length of BS information |
| | | | within the iteration of |
| | | | N_NEIGHBORS in bytes, |
| | | | except RS information |
| | | | within the iteration of |
| | | | N_RS. |
| | PHY synchronization info | TBD | Information for physical |
| | | | synchronization |
| | Neighbor station info | TBD | Information of this |
| | | | neighbor station |
| | TLV encoded neighbor | Variable | TLV specific |
| information | | | |
| | Relay info indicator | 1 | 0: RS information not |
| | | | included |
| | | | 1: RS information included |
| | Reserved | 7 | Shall be set to zero |
| | N_RS | 8 | Number of neighbor RSs in |

this BS (if relay info
indicator is set to 0,
this field shall be
discarded.)

For(j=0;j<N_RS;j++) {

| Length | 8 | Length of RS information |
|---|---|---|
| | | within the iteration of |
| | | N_RS in bytes. |
| PHY synchronization info | TBD | Information for physical |
| | | synchronization |
| RS info | TBD | Information of this RS |
| TLV encoded RS information | Vari- | TLV specific |

able

}

}

As shown in Table 4, the MOB_NBR-ADV message includes a relay info indicator that is added to each NEIGHBOR information in a conventional MOB_NBR-ADV message (defined in Table 1) to indicate whether there is an RS managed by a corresponding neighbor BS. When the relay info indicator is ‘0’, it indicates that the corresponding NEIGHBOR information does not include neighbor RS information. When the relay info indicator is ‘1’, it indicates that the corresponding NEIGHBOR information includes neighbor RS information. If the relay info indicator is ‘1’, the corresponding NEIGHBOR information includes not only information about a neighbor BS but also neighbor RS information managed by the neighbor BS. The neighbor RS information may include RS ID information, RS PHY synchronization information (e.g., physical channel profile information and RS frequency information), RS scheduling information supported by the RS, and an RS DCD message or an RS UCD message transmitted by the RS. In addition, a length field value (defined in Table 4) may indicate the amount of information about each NEIGHBOR, excluding the amount of neighbor RS information managed by the NEIGHBOR.

In step 713, the node starts to process information about each NEIGHBOR of the MOB_NBR-ADV message including the relay info indicator. A plurality of NEIGHBORs included in the MOB_NBR-ADV message may be sequentially processed. The subsequent process for each type of node will now be described.

A case where the node receiving the MOB_NBR-ADV message is an RS supporting a multi-hop relay communication mode will be described first.

In step 717, the node (RS) processes neighbor BS information included in corresponding NEIGHBOR information.

In step 719, the node (RS) determines if the relay info indicator in the corresponding NEIGHBOR information is ‘1’. If so, the procedure proceeds to step 721; and if not, the procedure proceeds directly to step 723. In step 721, the node (RS) detects that the corresponding NEIGHBOR information includes neighbor RS information, and processes the neighbor RS information in the corresponding NEIGHBOR information.

In step 723, the node (RS) determines if processing of information about all NEIGHBORS included in the MOB_NBR-ADV message is completed. If so, the procedure proceeds to step 725; and if not, the procedure returns to step 717 to process information about the next NEIGHBOR. In step 725, the node (RS) reconstructs neighbor BS/RS information included in the MOB_NBR-ADV message to generate a neighbor node information message, and transmits the generated neighbor node information message to lower nodes managed by the node (RS).

A case where the node receiving the MOB_NBR-ADV message is an MS supporting a multi-hop relay communication mode will now be described.

In step 729, the node (relay mode MS) processes neighbor BS information included in corresponding NEIGHBOR information.

In step 731, the node (relay mode MS) determines if the relay info indicator in the corresponding NEIGHBOR information is ‘1’. If so, the procedure proceeds to step 733; and if not, the procedure proceeds directly to step 735. In step 733, the node (relay mode MS) detects that the corresponding NEIGHBOR information includes neighbor RS information, and processes neighbor RS information in the corresponding NEIGHBOR information.

In step 735, the node (relay mode MS) determines if processing of information about all NEIGHBORS included in the MOB_NBR-ADV message is completed. If so, the procedure proceeds to step 737; and if not, the procedure returns to step 729 so as to process information about the next NEIGHBOR. In step 737, the node (relay mode MS) completes processing of neighbor node information.

A case where the node receiving the MOB_NBR-ADV message is an MS supporting a conventional IEEE 802.16e communication mode will now be described.

In step 741, the node (802.16e mode MS) processes neighbor BS information included in corresponding NEIGHBOR information.

In step 743, the node (802.16e mode MS) determines if the relay info indicator in the corresponding NEIGHBOR information is ‘1’. If so, the procedure proceeds to step 745; and if not, the procedure proceeds directly to step 747. In step 745, the node (802.16e mode MS) disregards (or discards) neighbor RS information following the relay info indicator.

In step 747, the node (802.16e mode MS) determines if processing of information about all NEIGHBORS included in the MOB_NBR-ADV message is completed. If so, the procedure proceeds to step 749; and if not, the procedure returns to step 741 so as to process information about the next NEIGHBOR. In step 749, the node (802.16e mode MS) completes processing of neighbor node information.

According to this example, using a relay info indicator added to a conventional MOB_NBR-ADV message, an 802.16e mode MS can determine whether the corresponding NEIGHBOR information includes the neighbor RS information.

Unlike a conventional MOB_NBR_ADV message defined in Table 1, an MOB_NBR-ADV message according to the present invention includes neighbor RS information for a multi-hop relay communication mode, as well as neighbor BS information for a conventional IEEE 802.16e communication mode. In this case, a length field is used to indicate whether the NEIGHBOR information includes neighbor RS information. This will be described below.

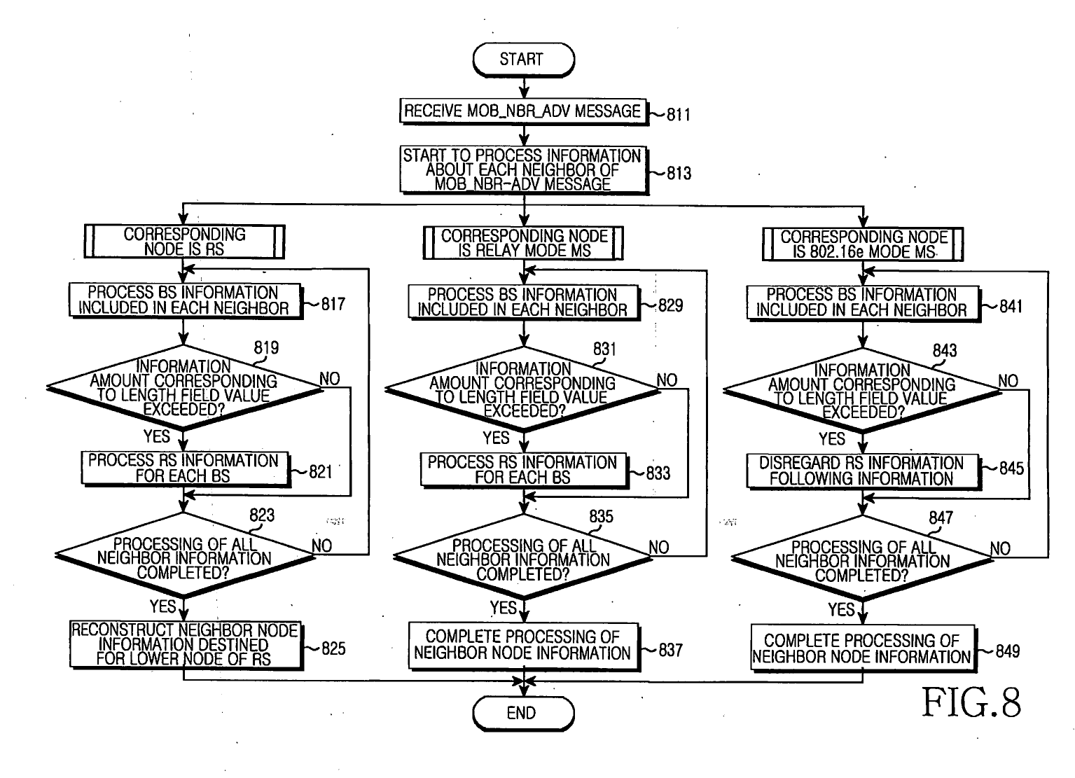

FIG. 8 shows another example of a procedure for receiving and processing a neighbor advertisement message in a multi-hop relay BWA system according to the present invention. A node receiving the neighbor advertisement message may be an RS, a relay mode MS, or an 802.16e mode MS.

Referring to FIG. 8, a node receives a neighbor advertisement (MOB_NBR-ADV) message broadcast by a BS, in step 811. The MOB_NBR-ADV message may include neighbor RS information for supporting the multi-hop relay communication mode, as well as the neighbor BS information defined in Table 1.

Table 5 below shows another example of a format of an MOB_NBR-ADV message including neighbor RS information according to the present invention. The neighbor BS information in the MOB_NBR-ADV message is the same as that defined in Table 1, and information about one NEIGHBOR is shows in Table 5.

TABLE 5

| ... | | . . . | . . . |
|---|---|---|---|
| N_NEIGHBORS | | 8 | Number of neighbor BSs |
| For(i=0; i<N_NEIGHBORS; | | | |
| i++) { | | | |
| | Length | 8 | Length of BS information |
| | | | within the iteration of |
| | | | N_NEIGHBORS in bytes, |
| | | | except RS information. |
| | PHY synchronization info | TBD | Information for physical |
| | | | synchronization |
| | Neighbor station info | TBD | Information of this |
| | | | neighbor station |
| | TLV encoded neighbor | Vari- | TLV specific |
| information | | able | |
| | N_RS | 8 | Number of neighbor RSs |

in this BS

For(j=0;j<N_RS;j++) {

| Length | 8 | Length of RS information |
|---|---|---|
| | | within the iteration of |
| | | N_RS in bytes. |
| PHY synchronization | TBD | Information for physical |
| info | | synchronization |
| RS info | TBD | Information of this RS |
| TLV encoded RS | Vari- | TLV specific |
| information | able | |

}

}

As shown in Table 5, the MOB_NBR-ADV message includes not only information about a corresponding neighbor BS but also neighbor RS information managed by the corresponding neighbor BS. Pure neighbor BS information, excluding the neighbor RS information, is recorded in a length field indicating the amount of information about each NEIGHBOR. Accordingly, the node having receiving the MOB_NRB-ADV message can recognize information corresponding to a length field value as the pure neighbor BS information and can recognize information exceeding the length field value as the neighbor RS information managed by the neighbor BS. The neighbor RS information may include RS ID information, RS PHY synchronization information (e.g., physical channel profile information and RS frequency information), RS scheduling information supported by the RS, and an RS DCD message or an RS UCD message transmitted by the RS.

In step 813, the node starts to process information about each NEIGHBOR of the received MOB_NBR-ADV message. A plurality of NEIGHBORs included in the MOB_NBR-ADV message may be sequentially processed. The subsequent process for each type of node will now be described in detail.

A case where the node receiving the MOB_NBR-ADV message is an RS supporting a multi-hop relay communication mode will be described first.

In step 817, the node (RS) processes neighbor BS information included in corresponding NEIGHBOR information.

In step 819, the node (RS) determines if the amount of the processed information exceeds the information amount corresponding to the length field value of the NEIGHBOR. If so, the procedure proceeds to step 821; and if not, the procedure proceeds directly to step 823. As described above, because the amount of information recorded in the length field value of the NEIGHBOR is the amount of the pure neighbor BS information, the node (RS) recognizes information corresponding to the length field value as the neighbor BS information. That is, if the amount of the processed information does not exceed the information amount corresponding to the length field value of the NEIGHBOR, the node (RS) detects that the corresponding NEIGHBOR information does not include the neighbor RS information.

In step 821, the node (RS) detects that the corresponding NEIGHBOR information includes neighbor RS information, and processes the neighbor RS information in the corresponding NEIGHBOR information.

In step 823, the node (RS) determines if processing of information about all NEIGHBORS included in the received MOB_NBR-ADV message is completed. If so, the procedure proceeds to step 825; and if not, the procedure returns to step 817 so as to process information about the next NEIGHBOR. In step 825, the node (RS) reconstructs neighbor BS/RS information included in the MOB_NBR-ADV message to generate a neighbor node information message, and transmits the generated neighbor node information message to lower nodes managed by the node (RS).

A case where the node receiving the MOB_NBR-ADV message is an MS supporting a multi-hop relay communication mode will now be described.

In step 829, the node (relay mode MS) processes neighbor BS information included in corresponding NEIGHBOR information.

In step 831, the node (relay mode MS) determines if the amount of the processed information exceeds the information amount corresponding to the length field value of the NEIGHBOR. If so, the procedure proceeds to step 833; and if not, the procedure proceeds directly to step 835. As described above, because the amount of information recorded in the length field value of the NEIGHBOR is the amount of the pure neighbor BS information, the node (RS) recognizes information corresponding to the length field value as the neighbor BS information. That is, if the amount of the processed information does not exceed the information amount corresponding to the length field value of the NEIGHBOR, the node (RS) detects that the corresponding NEIGHBOR information does not include the neighbor RS information.

In step 833, the node (relay mode MS) detects that the corresponding NEIGHBOR information includes neighbor RS information, and processes the neighbor RS information in the corresponding NEIGHBOR information.

In step 835, the node (relay mode MS) determines if processing of information about all NEIGHBORS included in the MOB_NBR-ADV message is completed. If so, the procedure proceeds to step 837; and if not, the procedure returns to step 829 so as to process information about the next NEIGHBOR. In step 837, the node (relay mode MS) completes processing of neighbor node information.

A case where the node receiving the MOB_NBR-ADV message is an MS supporting a conventional IEEE 802.16e communication mode will now be described.

In step 841, the node (802.16e mode MS) processes neighbor BS information included in corresponding NEIGHBOR information.

In step 843, the node (802.16e mode MS) determines if the amount of the processed information exceeds the information amount corresponding to the length field value of the NEIGHBOR. If so, the procedure proceeds to step 845; and if not, the procedure proceeds directly to step 847. As described above, because the information amount recorded in the length field value of the NEIGHBOR is the pure neighbor BS information amount, the node (802.16e mode MS recognizes the information corresponding to the length field value as the neighbor BS information. In this case, an N_RS field (defined in Table 5) indicating the number of neighbor RSs managed by the neighbor BS is meaningless to the node (802.16e mode MS). Accordingly, the node (806.16e mode MS) recognizes the remaining information corresponding to the length field value minus 8 bits of the N_RS field as an actual length value of the neighbor BS information.

In step 845, the node (802.16e mode MS) disregards (or discards) neighbor RS information following the information corresponding to the length field value.

In step 847, the node (802.16e mode MS) determines if processing of information about all NEIGHBORS included in the MOB_NBR-ADV message is completed. If so, the procedure proceeds to step 849; and if not, the procedure returns to step 841 so as to process information about the next NEIGHBOR. In step 849, the node (802.16e mode MS) completes processing of neighbor node information.

According to this example, using the length field of the corresponding NEIGHBOR, the 802.16e mode MS can acquire the pure neighbor BS information except neighbor RS information.

Configurations of the 802.16e mode MS, the relay mode MS, the RS, and the BS will be described in detail. The 802.16e mode MS, the relay mode MS, the RS, and the BS using the same interface module (communication module) have the same block configuration. Thus, the configurations of the 802.16e mode MS, the relay mode MS, the RS, and the BS will be described.

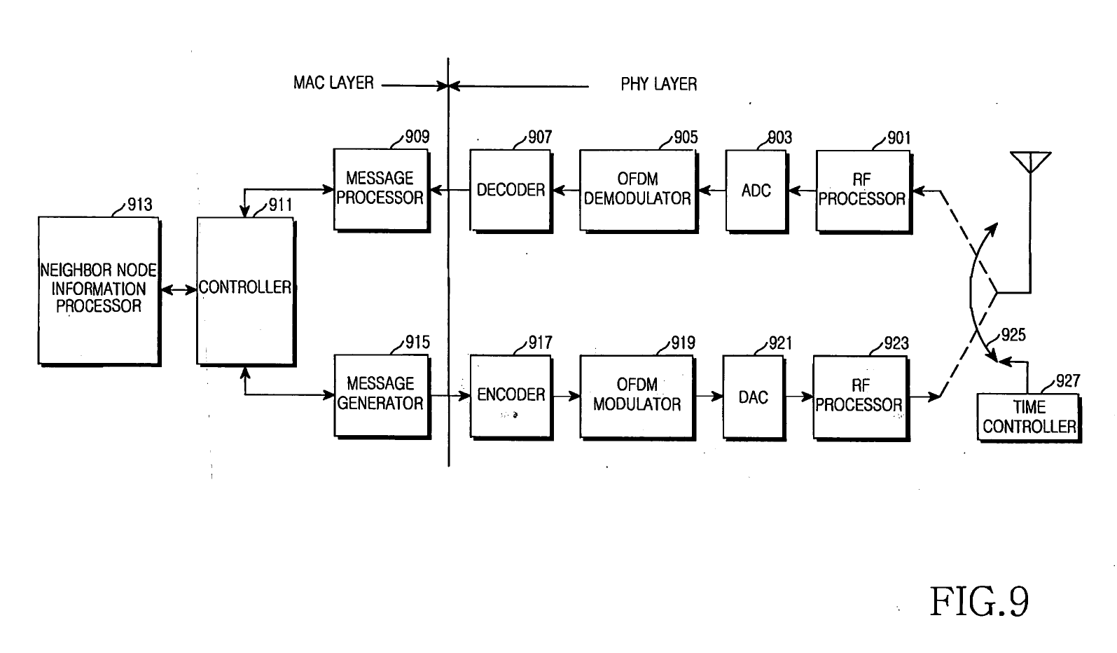

FIG. 9 shows an example of an 802.16e mode MS (a relay mode MS, an RS, or a BS) in a multi-hop relay BWA system according to the present invention. The following description will be made assuming that the MS (the relay mode MS, the RS, or the BS) uses a Time Division Duplex (TDD)/OFDMA scheme.

Referring to FIG. 9, the 802.16e mode MS (the relay mode MS, the RS, or the BS) includes an antenna, an RX radio frequency (RF) processor 901, an analog-to-digital converter (ADC) 903, an OFDM demodulator 905, a decoder 907, a message processor 909, a controller 911, a neighbor node information processor 913, a message generator 915, an encoder 917, an OFDM modulator 919, a digital-to-analog converter (DAC) 921, a TX RF processor 923, a switch 925, and a time controller 927.

The time controller 927 controls a switching operation of the switch 925 based on frame synchronization. For example, when being in an RX section of a frame, the time controller 927 controls the switch 925 so that the antenna is connected to the RX RF processor 901. When being in a TX section of the frame, the time controller 927 controls the switch 925 so that the antenna is connected to the TX RF processor 923.

In the RX section of the frame, the RX RF processor 901 converts an RF signal received through the antenna into a baseband analog signal. The ADC 903 converts the analog signal into sample data (digital data). The OFDM demodulator 905 Fast Fourier Transform (FFT)-processes the sample data to output frequency-domain data.

The decoder 907 selects data of desired subcarriers from the frequency-domain data, and decodes the selected data in accordance with a modulation & coding scheme (MCS) level.

The message processor 909 processes a control message received from the decoder 907 and provides the resulting information to the controller 911. According to the present invention, the message processor 909 extracts a variety of control information from the received control message and provides the extracted control information to the controller 911.

The controller 911 performs an operation corresponding to the information received from the message processor 909 and provides the results to the message generator 915. The neighbor node information processor 913 manages neighbor node information under the control of the controller 911.

The message generator 915 generates a message using a variety of information received from the controller 911 and provides the message to the encoder 917.

The encoder 917 encodes data received from the message generator 915 in accordance with an MCS level. The OFDM modulator 919 Inverse Fast Fourier Transform (IFFT)-processes data received from the encoder 917, thereby generating sample data (OFDM symbols). The DAC 921 converts the sample data into an analog signal. The TX RF processor 923 converts the analog signal received from the DAC 921 into an RF signal and transmits the RF signal through the antenna.

In the above-described configuration, the controller 911 is a protocol controller that controls the message processor 909, the message generator 915, and the neighbor node information processor 913. That is, the controller 911 can perform the functions of the message processor 909, the message generator 915, and the neighbor node information processor 913. Although separate units are provided for respective functions of the controller 911, the controller 911 can perform all or some of the functions instead of such separate units.

Operations of the 802.16e mode MS, the relay mode MS, the RS, and the BS will now be described with reference to the configuration shown in FIG. 9, focusing on a control message processing in a MAC layer.

The operation of the 802.16e mode MS will be first described.

The message processor 909 processes a control message received from a BS and provides the results to the controller 911. When the 802.163 mode MS receives a neighbor advertisement (MOB_NBR-ADV) message including neighbor BS information and neighbor RS information (defined in Table 2, Table 3, Table 4, or Table 5), the message processor 909 extracts a variety of information from the MOB_NBR-ADV message and provides the extracted information to the controller 911.

The controller 911 performs an operation corresponding to the information received from the message processor 909. At this point, the controller 911 processes only the neighbor BS information among the neighbor BS information and the neighbor RS information included in the MOB_NBR-ADV message.

The neighbor node information processor 913 manages the neighbor BS information extracted from the MOB_NBR-ADV message. Under the control of the controller 911, the neighbor node information processor 913 reads information necessary for communication with a corresponding node (BS or RS) BS and provides the read information to the controller 911.

The operation of the relay mode MS will now be described.

The message processor 909 processes a control message received from an RS or a BS and provides the results to the controller 911. When the relay mode MS receives a neighbor advertisement (MOB_NBR-ADV) message including neighbor BS information and neighbor RS information (defined in Table 2, Table 3, Table 4, or Table 5), the message processor 909 extracts a variety of information from the MOB_NBR-ADV message and provides the extracted information to the controller 911.

The controller 911 performs an operation corresponding to the information received from the message processor 909. At this point, the controller 911 discriminatively processes both of the neighbor BS information and the neighbor RS information included in the MOB_NBR-ADV message.

The neighbor node information processor 913 manages the neighbor BS information and the neighbor RS information extracted from the MOB_NBR-ADV message. Under the control of the controller 911, the neighbor node information processor 913 reads information necessary for communication with a corresponding node (BS or RS) and provides the read information to the controller 911.

The operation of the RS will now be described.

The message processor 909 processes a control message received from an MS or a BS and provides the results to the controller 911. When the RS receives a neighbor advertisement (MOB_NBR-ADV) message including neighbor BS information and neighbor RS information (defined in Table 2, Table 3, Table 4, or Table 5), the message processor 909 extracts a variety of information from the MOB_NBR-ADV message and provides the extracted information to the controller 911.

The controller 911 performs an operation corresponding to the information received from the message processor 909. At this point, the controller 911 discriminatively processes both of the neighbor BS information and the neighbor RS information included in the MOB_NBR-ADV message.

The neighbor node information processor 913 manages the neighbor BS information and the neighbor RS information extracted from the MOB_NBR-ADV message. Under the control of the controller 911, the neighbor node information processor 913 reads information necessary for communication with a corresponding node (BS or RS) and provides the read information to the controller 911.

Under the control of the controller 911, the message generator 915 generates a message destined for a BS, a relay mode MS, or a lower node (RS) and provides the generated message to the encoder 917 of a physical layer. According to the present invention, using the neighbor BS information and the neighbor RS information managed by the neighbor node information processor 913, the message generator 915 generates a neighbor node information message destined for a lower node of the physical layer. The generated neighbor node information message is processed at the physical layer and is transmitted through the antenna.

The operation of the BS will now be described.

The message processor 909 processes a control message received from an MS or an RS and provides the results to the controller 911.

The controller 911 performs an operation corresponding to control information received from the message processor 909. The neighbor node information processor 913 manages neighbor BS information and neighbor RS information, and provides a neighbor node list to the controller 911 under the control of the controller 911.

Under the control of the controller 911, the message generator 915 generates a message destined for an MS or an RS and provides the generated message to the encoder 917 of a physical layer. According to the present invention, the message generator 915 generates a neighbor advertisement (MOB_NBR-ADV) message including neighbor BS information and neighbor RS information (defined in Table 2, Table 3, Table 4, or Table 5), and provides the MOB_NBR-ADV message to the physical layer. Thereafter, the MOB_NBR-ADV message is processed suitable for communication and is transmitted through the antenna.

As described above, the neighbor advertisement message including the neighbor BS information and the neighbor RS information is broadcast in the BWA system where the 802.16e mode MS, the relay mode MS, the BS, and the RS coexist. In this case, each node can extract and process necessary neighbor node information efficiently. In addition, the present invention can provide a scheme for enabling the 802.16e mode MS to disregard the neighbor RS information contained in the neighbor advertisement message. Accordingly, it is possible to prevent unnecessary information processing.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for transmitting a neighbor advertisement message in a cellular communication system, the method comprising the steps of:
generating a neighbor advertisement message including neighbor Base Station (BS) information and neighbor Relay Station (RS) information; and
processing and broadcasting the generated neighbor advertisement message in accordance with a transport protocol.

2. The method of claim 1, wherein the neighbor BS information or the neighbor RS information includes one of identification (ID) information, information necessary for acquisition of synchronization, handover optimization information, scheduling information, Downlink Channel Description (DCD) information, and Uplink Channel Description (UCD) information.

3. The method of claim 1, wherein the neighbor advertisement message includes at least one piece of neighbor node information, and each piece of the neighbor node information includes neighbor BS information and neighbor RS information configured in a Type/Length/Value (TLV) format.

4. The method of claim 1, wherein the neighbor advertisement message includes at least one piece of neighbor node information, and each piece of the neighbor node information includes an indicator for indicating whether the neighbor node information is neighbor BS information or neighbor RS information.

5. The method of claim 1, wherein the neighbor advertisement message includes at least one piece of neighbor node information, and each piece of the neighbor node information includes an indicator for indicating whether the neighbor node information includes neighbor RS information.

6. The method of claim 1, wherein the neighbor advertisement message includes at least one piece of neighbor node information, each piece of the neighbor node information includes neighbor BS information and neighbor RS information, and a length field of the neighbor node information is set to an amount of the neighbor BS information.

7. A method for processing a neighbor advertisement message in a cellular communication system, the method comprising the steps of:
receiving a neighbor advertisement message broadcast by a Base Station (BS); and
discriminatively processing neighbor BS information and neighbor Relay Station (RS) information included in the neighbor advertisement message.

8. The method of claim 7, further comprising reconstructing the processed BS information and the processed RS information and transmitting a resulting message to a lower RS when a node receiving the neighbor advertisement message is an RS.

9. The method of claim 7, further comprising discarding the neighbor RS information in the neighbor advertisement message when a node receiving the neighbor advertisement message is an MS incapable of performing relay communication.

10. The method of claim 7, wherein the step of discriminatively processing comprises:
extracting and processing neighbor BS information for each piece of neighbor node information;
determining if a corresponding neighbor node information includes RS Type/Length/Value (TLV) information; and
extracting and processing neighbor RS information included in the corresponding neighbor node information when the corresponding neighbor node information includes RS information TLV.

11. The method of claim 7, wherein the step of discriminatively processing comprises:
detecting an indicator for each piece of neighbor node information; and
processing the corresponding neighbor node information as neighbor BS information when the indicator indicates a neighbor BS.

12. The method of claim 7, wherein the step of discriminatively processing comprises:
extracting and processing neighbor BS information for each piece of neighbor node information;
detecting an indicator for each piece of neighbor node information to determine if the corresponding neighbor node information includes neighbor RS information; and
extracting and processing neighbor RS information included in the corresponding neighbor node information when the corresponding neighbor node information includes neighbor RS information.

13. The method of claim 7, wherein the step of discriminatively processing comprises:
detecting a length field value for each piece of neighbor node information; and
processing a portion of the neighbor node information corresponding to the length field value as neighbor BS information and processing remaining information as neighbor RS information.

14. A Base Station (BS) apparatus for a cellular communication system, the BS apparatus comprising:
a message generator for generating a neighbor advertisement message including neighbor BS information and neighbor Relay Station (RS) information; and
a transmitter for processing and broadcasting the generated neighbor advertisement message in accordance with a transport protocol.

15. The BS apparatus of claim 14, wherein the neighbor BS information or the neighbor RS information includes one of identification (ID) information, information necessary for acquisition of synchronization, handover optimization information, scheduling information, Downlink Channel Description (DCD) information, and Uplink Channel Description (UCD) information.

16. The BS apparatus of claim 14, wherein the neighbor advertisement message includes at least one piece of neighbor node information and each piece of the neighbor node information includes neighbor BS information and neighbor RS information configured in a Type/Length/Value (TLV) format.

17. The BS apparatus of claim 14, wherein the neighbor advertisement message includes at least one piece of neighbor node information and an indicator for indicating whether each piece of the neighbor node information is neighbor BS information or neighbor RS information.

18. The BS apparatus of claim 14, wherein the neighbor advertisement message includes at least one piece of neighbor node information and an indicator for indicating whether each piece of the neighbor node information includes neighbor RS information.

19. The BS apparatus of claim 14, wherein the neighbor advertisement message includes at least one piece of neighbor node information, each piece of the neighbor node information includes neighbor BS information and neighbor RS information, and a length field of the neighbor node information is set to an amount of the neighbor BS information.

20. A node apparatus for a cellular communication system, the node apparatus comprising:
a receiver for receiving a neighbor advertisement message broadcast by a Base Station (BS); and
a message processor for discriminatively processing neighbor BS information and neighbor Relay Station (RS) information included in the received neighbor advertisement message.

21. The node apparatus of claim 20, further comprising, when a node receiving the neighbor advertisement message is an RS:
a message generator for reconstructing the processed BS information and the processed RS information to generate a neighbor information message; and
a transmitter for processing and transmitting the generated neighbor advertisement message to a lower RS in accordance with a transport protocol.

22. The node apparatus of claim 20, wherein the message processor discards the neighbor RS information in the neighbor advertisement message when a node receiving the neighbor advertisement message is an MS incapable of performing relay communication.

23. The node apparatus of claim 20, wherein the neighbor advertisement message includes at least one piece of neighbor node information, and each piece of the neighbor node information includes neighbor BS information and neighbor RS information configured in a Type/Length/Value (TLV) format.

24. The node apparatus of claim 20, wherein the neighbor advertisement message includes at least one piece of neighbor node information, and each piece of the neighbor node information includes an indicator for indicating whether the neighbor node information is neighbor BS information or neighbor RS information.

25. The node apparatus of claim 20, wherein the neighbor advertisement message includes at least one piece of neighbor node information, and each piece of the neighbor node information includes an indicator for indicating whether the neighbor node information includes neighbor RS information.

26. The node apparatus of claim 20, wherein the neighbor advertisement message includes at least one piece of neighbor node information, each piece of the neighbor node information includes neighbor BS information and neighbor RS information, and a length field of the neighbor node information is set to an amount of the neighbor BS information.

27. A method for communicating a neighbor advertisement message in a cellular communication system, the method comprising the steps of:
generating and broadcasting, at a Base Station (BS), a neighbor advertisement message including neighbor base station BS information and neighbor Relay Station (RS) information; and
discriminatively processing, at a node, the neighbor BS information and the neighbor RS information included in the neighbor advertisement message received from the BS.

28. The method of claim 27, wherein the node is one of an RS, a Mobile Station (MS) supporting a relay communication mode, and an MS communicating directly with the BS.

29. The method of claim 27, wherein the neighbor advertisement message includes at least one piece of neighbor node information, and each piece of the neighbor node information includes neighbor BS information and neighbor RS information configured in a Type/Length/Value (TLV) format.

30. The method of claim 27, wherein the neighbor advertisement message includes at least one piece of neighbor node information, and each piece of the neighbor node information includes an indicator for indicating whether the neighbor node information is neighbor BS information or neighbor RS information.

31. The method of claim 27, wherein the neighbor advertisement message includes at least one piece of neighbor node information, and each piece of the neighbor node information includes an indicator for indicating whether the neighbor node information includes neighbor RS information.

32. The method of claim 27, wherein the neighbor advertisement message includes at least one piece of neighbor node information, each piece of the neighbor node information includes neighbor BS information and neighbor RS information, and a length field of the neighbor node information is set to an amount of the neighbor BS information.

33. The method of claim 27, further comprising reconstructing, at the node, the processed neighbor BS information and the processed RS information and transmitting a resulting message to a lower RS.
